(19) United States
(12) Patent Application Publication
(10) Pub. No.: US 2020/0035185 A1
(43) Pub. Date: Jan. 30, 2020

(54) DISPLAY DEVICE

(71) Applicant: Sharp Kabushiki Kaisha, Sakai City (JP)

(72) Inventors: Takayuki NISHIYAMA, Sakai City (JP); Kohhei TANAKA, Sakai City (JP); Youhei NAKANISHI, Sakai City (JP)

(21) Appl. No.: 16/522,702

(22) Filed: Jul. 26, 2019

Related U.S. Application Data
(60) Provisional application No. 62/711,653, filed on Jul. 30, 2018.

(51) Int. Cl. G09G 3/36

(52) U.S. Cl. CPC G09G 3/3677; G09G 2310/0243; G09G 3/3688

(57) ABSTRACT

A display device includes, inside a display region having a nonrectangular shape, groups of gate lines and groups of gate drivers. A pulse generator transmits a scan start signal to a first group of gate drivers, among the groups of gate drivers, that includes a gate driver to start a scanning in a single vertical scan period. To other group of gate drivers than the first group of gate drivers, a scan signal is transmitted by the pulse generator or a group of gate drivers that scans the gate lines before the other group of gate drivers during the single vertical scan period. A scan end signal is transmitted to each of the groups of gate drivers by the pulse generator or a group of gate drivers to scan the gate lines subsequently to the each of the groups of gate drivers during the single vertical scan period.

### TECHNICAL FIELD

The following disclosure relates to a display device, and particularly relates to a display device including circuit elements constituting a gate driver configured to drive a gate line, at least part of the circuit elements being disposed inside a display region.

### BACKGROUND ART

Conventionally, there have been quite typically used display devices each having a display region in a rectangular shape. Other than these, there have been known display devices in circular, elliptical, or upwardly projecting shapes. For example, JP 2008-292995 A discloses a display device having a display screen in a nonrectangular shape and including a plurality of drive circuits divided and disposed in a frame region. This configuration needs spaces for the drive circuits and control lines that are disposed in the frame region, and there is limitation on reduction in size of the frame region.

There has also been known a configuration in which a gate driver is disposed inside a display region (see WO 2016/039184 A and the like). Reduction in size of a frame region can be enabled with such disposition, inside the display region, of at least part of a circuit constituting the gate driver.

### SUMMARY OF INVENTION

At least part of the circuit elements constituting the gate driver disposed inside the display region as described above enables reduction in size of the frame region as well as relatively facilitated provision of the so-called nonrectangular display having a display region in a shape other than the rectangular shape.

Nonrectangular displays have been conventionally limited to have relatively simple shapes such as circular, elliptical, or upwardly projecting shapes. For achievement of a display having a freer shape, a display region may be divided into a plurality of partial regions each provided with gate lines that are driven by a group of gate driver monolithic circuits (GDM circuits). Variously combining such partial regions each provided with the gate lines driven by the group of GDM circuits enables a nonrectangular display having a complicated shape.

With the display region including the plurality of partial regions, harmonic display in the entire display region needs appropriate control of start and end of driving by groups of GDM circuits configured to drive the gate lines in the respective partial regions. In view of this, it is an object of the following disclosure to appropriately control entire display in a nonrectangular display having a plurality of groups of GDM circuits.

In order to achieve the object mentioned above, a display device according to an embodiment includes, inside a display region having a nonrectangular shape: a plurality of gate lines; a plurality of source lines crossing the plurality of gate lines; and a plurality of gate drivers configured to respectively drive the plurality of gate lines. he display device further includes a pulse generator provided outside the display region. The plurality of gate lines include a plurality of groups of gate lines different in at least either scan start lines or scan end lines. The plurality of gate drivers include a plurality of groups of gate drivers respectively for the plurality of groups of gate lines. The pulse generator transmits a scan start signal to a first group of gate drivers, among the plurality of groups of gate drivers, that includes a gate driver configured to drive a gate line from which a scanning in a single vertical scan period starts. To other group of gate drivers than the first group of gate drivers, among the plurality of groups of gate drivers, a scan signal is transmitted by the pulse generator or a group of gate drivers that scans the gate lines before the other group of gate drivers during the single vertical scan period. A scan end signal is transmitted to each of the plurality of groups of gate drivers by the pulse generator or a group of gate drivers configured to scan the gate lines subsequently to the each of the plurality of groups of gate drivers during the single vertical scan period.

The configuration described above enables provision of a nonrectangular display including a plurality of GDM circuits configured to control display.

### BRIEF DESCRIPTION OF DRAWINGS

FIG. 1 is a pattern diagram depicting a schematic configuration of a display device according to a first embodiment.

FIG. 2 is an equivalent circuit diagram depicting an exemplary configuration of a gate driver 100 configured to drive a gate line GL(n) according to the first embodiment.

FIG. 3 is a circuit diagram depicting connection relation between gate drivers 100 and control signal lines in each of regions G1 and G2 according to the first embodiment.

FIG. 4 is a waveform chart of signals received by a gate driver 100(N) in the last row in the region G1.

FIG. 5 is a waveform chart according to a comparative example, indicating oscillation of a gate line GL(N) in a case where the gate driver 100(N) in the last row in the region G1 does not receive a clear signal (CLR1).

FIG. 6 is a circuit diagram depicting connection relation between gate drivers 100 and control signal lines in each of regions G1 and G2 according to a second embodiment.

FIG. 7 is a pattern diagram depicting a schematic configuration of a display device according to the second embodiment.

FIG. 8 is a waveform chart of signals received by a gate driver 100(N) in the last row in the region G1 according to the second embodiment.

FIG. 9 is a circuit diagram depicting connection relation between gate drivers 100 and control signal lines in each of regions G1 and G2 according to a third embodiment.

FIG. 10 is a waveform chart of signals received by a gate driver 100(N) in the last row in the region G1 according to the third embodiment.

FIG. 11 is a circuit diagram depicting connection relation between gate drivers 100 and control signal lines in each of regions G1 and G2 according to a fourth embodiment.

FIG. 12 is a waveform chart of signals received by a gate driver 100(N) in the last row in the region G1 according to the fourth embodiment.

### DESCRIPTION OF EMBODIMENTS

A display device according to a first configuration includes, inside a display region having a nonrectangular shape:
a plurality of gate lines;
a plurality of source lines crossing the plurality of gate lines; and
a plurality of gate drivers configured to respectively drive the plurality of gate lines;
the display device further including:
a pulse generator provided outside the display region; wherein
the plurality of gate lines include a plurality of groups of gate lines different in at least either scan start lines or scan end lines,
the plurality of gate drivers include a plurality of groups of gate drivers respectively for the plurality of groups of gate lines,
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by the pulse generator or a group of gate drivers that scans the gate lines before the other group of gate drivers during the single vertical scan period, and
a scan end signal is transmitted to each of the plurality of groups of gate drivers by the pulse generator or a group of gate drivers configured to scan the gate lines subsequently to the each of the plurality of groups of gate drivers during the single vertical scan period.

In the nonrectangular display region according to the first configuration, the plurality of groups of gate lines is locally driven (scanned) respectively by the plurality of groups of gate drivers. The nonrectangular display region can be achieved with the groups of gate lines and the groups of gate drivers having lengths matching local shapes to serve as the display region and appropriately disposed. The pulse generator transmits a scan start signal to a first group of gate drivers, among the plurality of groups of gate drivers, that includes a gate driver configured to drive a gate line from which a scanning in a single vertical scan period starts. To other group of gate drivers than the first group of gate drivers, among the plurality of groups of gate drivers, a scan signal is transmitted by the pulse generator or a group of gate drivers that scans the gate lines before the other group of gate drivers during the single vertical scan period. A scan end signal is transmitted to each of the plurality of groups of gate drivers by the pulse generator or a group of gate drivers configured to scan the gate lines subsequently to the each of the plurality of groups of gate drivers during the single vertical scan period. The plurality of groups of gate drivers can thus sequentially scan the plurality of groups of gate lines in the display region.

The present invention provides a display device according to a second configuration, in which, in the first configuration, particularly,
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by the pulse generator, and
a scan end signal is transmitted to each of the plurality of groups of gate drivers by the pulse generator.

In an exemplary case of having difficulty in disposing lines among the plurality of groups of gate drivers in the configuration in which the plurality of groups of gate drivers sequentially scans the plurality of groups of gate lines, the second configuration enables all the groups of gate lines to be sequentially scanned by input of the scan start signals and the scan end signals from the pulse generator disposed outside the display region.

The present invention provides a display device according to a third configuration, in which, in the first configuration, particularly,
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by the pulse generator, and
the plurality of groups of gate drivers includes a group of gate drivers to which a scan end signal is transmitted by a subsequent group of gate drivers configured to scan the gate lines subsequently to the group of gate drivers during the single vertical scan period.

According to the third configuration, the plurality of groups of gate drivers includes the group of gate drivers configured to receive the scan end signals from the group of gate drivers configured to scan the gate lines subsequently to the group of gate drivers during the single vertical scan period. In comparison to the second configuration, this configuration achieves reduction in the number of input signals from the pulse generator to the groups of gate drivers.

The present invention provides a display device according to a fourth configuration, in which, in the first configuration, particularly,
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by a group of gate drivers that scans the gate lines before the other group of gate drivers during the single vertical scan period, and
a scan end signal is transmitted to each of the plurality of groups of gate drivers by the pulse generator.

According to the fourth configuration, to other group of gate drivers than the first group of gate drivers, among the plurality of groups of gate drivers, a scan signal is transmitted by a group of gate drivers that scans the gate lines before the other group of gate drivers during the single vertical scan period. In comparison to the second configuration, this configuration achieves reduction in the number of input signals from the pulse generator to the groups of gate drivers.

The present invention provides a display device according to a fifth configuration, in which, in the first configuration, particularly,
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by a group of gate drivers that scans the gate lines before the other group of gate drivers during the single vertical scan period, and
the plurality of groups of gate drivers includes a group of gate drivers to which a scan end signal is transmitted by a subsequent group of gate drivers configured to scan the gate lines subsequently to the group of gate drivers during the single vertical scan period.

According to the fifth configuration, to other group of gate drivers than the first group of gate drivers, among the plurality of groups of gate drivers, a scan signal is transmitted by a group of gate drivers that scans the gate lines before the other group of gate drivers during the single vertical scan period, and the plurality of groups of gate drivers includes a group of gate drivers to which a scan end signal is transmitted by a subsequent group of gate drivers configured to scan the gate lines subsequently to the group of gate drivers during the single vertical scan period. In comparison to the second to fourth configurations, this configuration achieves reduction in the number of input signals from the pulse generator to the groups of gate drivers.

Embodiments of the present invention will now be described in detail below with reference to the drawings. Identical or corresponding parts in the drawings will be denoted by identical reference signs and will not be described repeatedly. For clearer description, the drawings to be referred to hereinafter may depict simplified or schematic configurations or may not include some of constituent elements. The constituent elements in each of the drawings may not necessarily be depicted in actual dimensional ratios.

### FIRST EMBODIMENT

### (Schematic Configuration of Display Device)

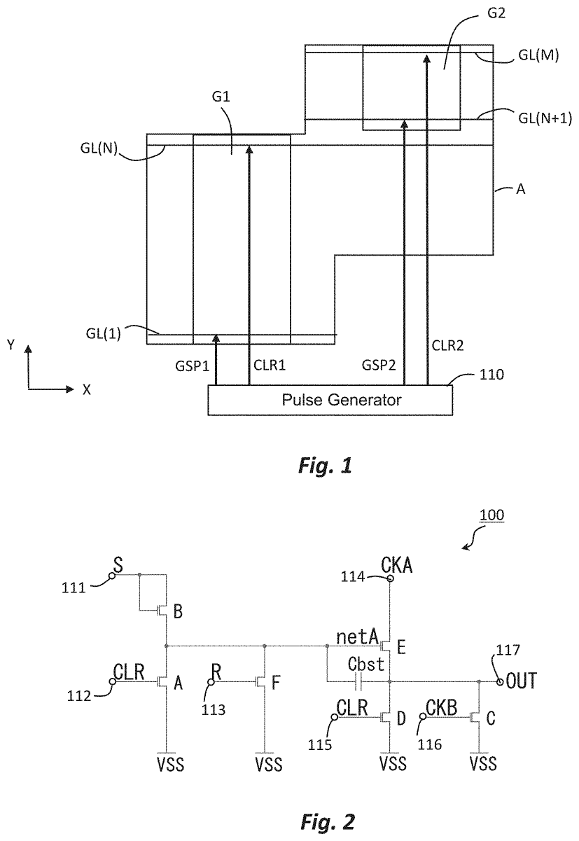

FIG. 1 is a pattern diagram depicting a schematic configuration of a display device according to the present embodiment. The present embodiment provides a display device 1 that can be configured as a liquid crystal display device including an active matrix substrate, a counter substrate (none depicted), and liquid crystals interposed between the active matrix substrate and the counter substrate. As depicted in FIG. 1, the display device 1 has a display region A in a nonrectangular shape. The “nonrectangular shape” indicates a nonrectangular outer edge in the present description. The display region A depicted in FIG. 1 has a shape obtained by coupling two rectangles partially overlapped with each other, and examples of the “nonrectangular shape” also include such a shape.

The display region A is provided with a plurality of gate lines GL extending in an X direction indicated in FIG. 1, and a plurality of source lines SL (not depicted) extending in a Y direction. The gate lines GL and the source lines SL have intersections around each of which there are disposed a thin film transistor (TFT) functioning as a pixel switching element and a pixel electrode according to a known aspect. The TFT includes a gate terminal and a source terminal connected to a corresponding one of the gate lines GL and a corresponding one of the source lines SL, respectively, and the TFT further includes a drain terminal connected to the pixel electrode.

There is disposed, outside the display region A, a source driver according to a known aspect, configured to drive the source lines SL. The source driver may be provided on the active matrix substrate, or may be provided outside the active matrix substrate (e.g. on a flexible substrate).

In contrast, the display region A is provided therein with gate drivers configured to drive the plurality of gate lines GL. In other words, the display region A includes elements constituting the gate drivers. FIG. 1 depicts regions G1 and G2 provided with the elements constituting the gate drivers.

Specifically, in the display region A depicted in FIG. 1, the region G1 includes the elements of the gate drivers for gate lines GL(1) to GL(N). The region G2 includes the elements of the gate drivers for gate lines GL(N+1) to GL(M). The gate drivers in the region G1 drive the gate lines GL(1) to GL(N) in the mentioned order, and the gate drivers in the region G2 subsequently drive the gate lines GL(N+1) to GL(M) in the mentioned order. The elements disposed in the region G1 constitute a first group of GDM circuits configured to drive the gate lines GL(1) to GL(N), whereas the elements disposed in the region G2 constitute a second group of GDM circuits configured to drive the gate lines GL(N+1) to GL(M).

### (Basic Configuration of Gate Driver)

The gate drivers will be described below in terms of their configuration. FIG. 2 is an equivalent circuit diagram depicting an exemplary configuration of a gate driver 100 configured to drive a single gate line GL (assumed to be a gate line GL(n) in this case). The region G1 and the region G2 include the gate drivers 100 configured identically. The gate driver 100 depicted in FIG. 2 includes a TFT-A to a TFT-F and a capacitor Cbst.

The gate driver 100 further includes input terminals 111 to 116 and an output terminal 117. The terminal 111 receives a start signal (S). The terminal 112 and the terminal 115 each receive a clear signal (CLR). The terminal 113 receives a reset signal (R).

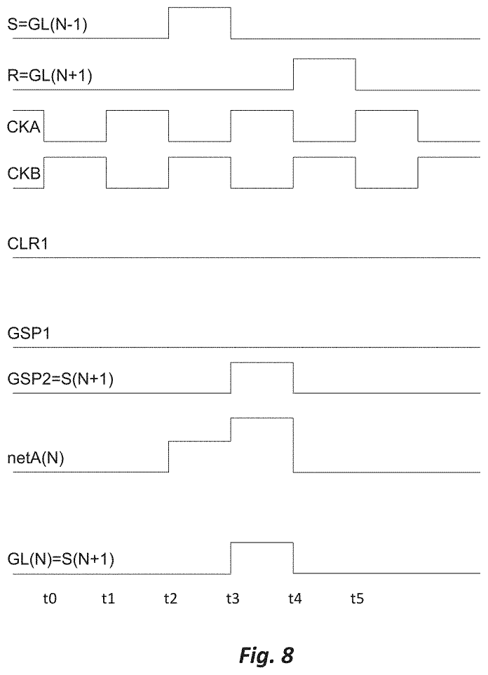

A clock signal (CKA) and a clock signal (CKB) are two-phase clock signals each having a phase reversed during each horizontal scan period (see FIG. 8). FIG. 2 exemplarily depicts the gate driver 100 that is configured to drive the gate line GL(n) and includes the terminal 114 configured to receive the clock signal (CKA) and the terminal 116 configured to receive the clock signal (CKB). In each of the gate driver 100 disposed in a preceding row and configured to drive a gate line GL(n−1) and the gate driver 100 disposed in a subsequent row and configured to drive a gate line GL(n+1), the terminal 114 receives the clock signal (CKB) and the terminal 116 receives the clock signal (CKA). The terminal 114 and the terminal 116 in the gate driver 100 receive the clock signals having the phases opposite to the phases of the clock signals received by the gate drivers 100 in the adjacent rows (specifically, in the preceding and subsequent rows).

FIG. 2 depicts a line netA connected to the source terminal of the TFT-B, the drain terminal of the TFT-A, the drain terminal of the TFT-F, a first electrode of the capacitor Cbst, and the gate terminal of the TFT-E.

The gate terminal of the TFT-A receives the clear signal (CLR) from the terminal 112. The source terminal of the TFT-A is supplied with power supply voltage (VSS). The drain terminal of the TFT-A is connected to the netA.

The gate terminal and the drain terminal of the TFT-B are connected (diode connected) to each other. The source terminal of the TFT-B is connected to the netA.

The gate terminal of the TFT-F receives the reset signal (R) from the terminal 113. In the TFT-F, the drain terminal is connected to the netA, and the source terminal is supplied with the power supply voltage (VSS). The reset signal (R) to be received is gate output (OUT) of the gate driver 100 for the gate line GL in the subsequent row. Specifically, the terminal 113 of the gate driver 100 for the gate line GL(n) receives the gate output (OUT) of the gate driver 100 for the gate line GL(n+1).

The capacitor Cbst includes the first electrode connected to the netA and a second electrode connected to the source terminal of the TFT-E and the drain terminal of the TFT-D.

The gate terminal of the TFT-C receives the clock signal (CKB) from the terminal 116. In the TFT-C, the drain terminal is connected to the output terminal 117 of the gate driver 100, and the source terminal is supplied with the power supply voltage (VSS). The output terminal 117 of the gate driver 100 is connected to the gate line GL(n) driven by this gate driver 100 and the terminal 111 of the gate driver 100 for the gate line GL(n+1) in the subsequent row.

The gate terminal of the TFT-D receives the clear signal (CLR) from the terminal 115. In the TFT-D, the drain terminal is connected to the capacitor Cbst, the source terminal of the TFT-E, and the output terminal 117, and the source terminal is supplied with the power supply voltage (VSS).

In the TFT-E, the gate terminal is connected to the netA, and the drain terminal receives the clock signal (CKA). Furthermore, the source terminal is connected to the output terminal 117.

FIG. 1 does not depict lines that are used for supply of the clock signals (CKA and CKB), the clear signal (CLR), and the power supply voltage (VSS), are disposed inside the display region A, and extend in parallel with the source lines SL.

The TFT-A, the TFT-B, and the TFT-F depicted in FIG. 2 may alternatively be configured by two or more TFTs connected in series.

The plurality of gate drivers 100 is preferred to be provided for each of the gate lines GL(1) to GL(M). The plurality of gate drivers 100 provided for the single gate line GL operates in synchronization in this case. Provision of the plurality of gate drivers 100 for the single gate line GL exhibits the following advantages in comparison to a conventional configuration in which a gate driver is provided outside a display region and a scan signal (drive voltage) is inputted to an end of a gate line. Firstly, the plurality of gate drivers 100 supplies scan signals to the single gate line GL to reduce distortions of the scan signals and enable driving (scanning) of the gate line at high speed. Furthermore, the plurality of gate drivers 100 is connected to the single gate line GL. Even in a case where the gate line GL is broken, a scan signal is supplied through any other portion for maintenance of appropriate image display. The plurality of gate drivers 100 provided for the single gate line GL is preferred to be disposed substantially at equal intervals along the gate line GL so as to have substantially equal loads.

Provision of the gate drivers 100 in the display region A achieves reduction in area of a region irrelevant to display (i.e. an area of a region excluding the display region A) in comparison to a configuration in which gate drivers are disposed around a display region.

The gate drivers 100 for the gate lines GL(1) and GL(N+1) to be initially driven in the regions G1 and G2 each receive, as a scan start signal (the start signal (S)), a gate start pulse signal from a pulse generator 110 provided outside the display region A. The pulse generator 110 may be provided outside the display region A on the active matrix substrate or may be provided outside the active matrix substrate. The gate drivers 100 for the gate lines GL(2) to GL(N) receive, as the start signals (S), the gate output (OUT) of the gate drivers 100 for the gate lines GL(1) to GL(N−1) in the preceding rows, respectively. The gate drivers 100 for the gate lines GL(N+2) to GL(M) also receive, as the start signals (S), the gate output (OUT) of the gate drivers 100 for the gate lines GL(N+1) to GL(M−1) in the preceding rows, respectively.

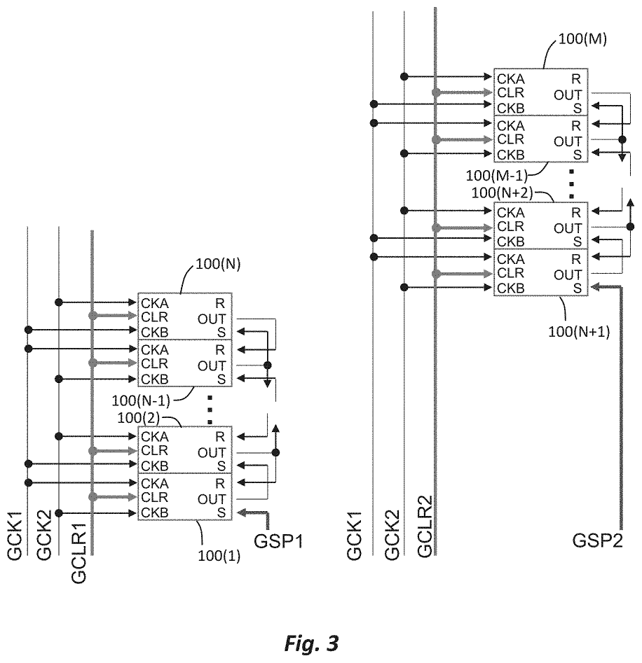

FIG. 3 is a circuit diagram depicting connection relation between the gate drivers 100 and control signal lines in each of the regions G1 and G2. FIG. 3 depicts gate drivers 100(1) to 100(N) configured to drive the gate lines GL(1) to GL(N), respectively. FIG. 3 also depicts gate drivers 100(N+1) to 100(M) configured to drive the gate lines GL(N+1) to GL(M), respectively. The following description will simply refer to the “gate drivers 100” when the gate drivers are not distinguished individually.

The control signal lines include a line (GCK1) and a line (GCK2) for supply of the clock signals (CKA) and the clock signals (CKB) to the gate drivers 100(1) to 100(N) in the region G1 and the gate drivers 100(N+1) to 100(M) in the region G2.

A line (GCLR1) is used for supply of clear signals (CLR1) from the pulse generator 110 to the gate drivers 100(1) to 100(N) in the region G1. A line (GCLR2) is used for supply of clear signals (CLR2) from the pulse generator 110 to the gate drivers 100(N+1) to 100(M) in the region G2.

As depicted in FIG. 3, the gate driver 100(1) in the first row in the region G1 receives, as the start signal (S), a gate start pulse (GSP1) from the pulse generator 110. Furthermore, the gate driver 100(N+1) in the first row in the region G2 receives, as the start signal (S), a gate start pulse (GSP2) from the pulse generator 110.

In the case where the plurality of gate drivers 100 is provided for the single gate line GL, the control signal lines depicted in FIG. 3 are equal in the number to the gate drivers 100 provided for the single gate line GL.

### (Operation of Gate Driver)

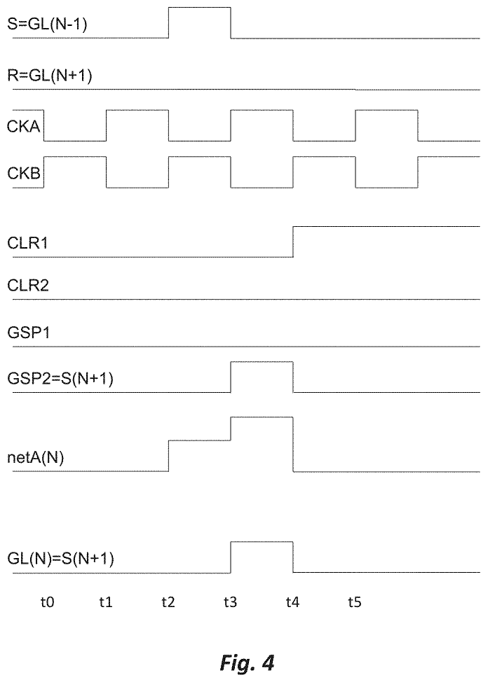

The gate driver 100 will be described next in terms of its operation with reference to FIG. 4. FIG. 4 is a waveform chart of signals received by the gate driver 100(N) in the last row in the region G1.

From time t0 to time t1 indicated in FIG. 4, the drain terminal of the TFT-E receives the clock signal (CKA) at an L level, and the gate terminal of the TFT-C receives the clock signal (CKB) at an H level. The TFT-C comes into an ON state and the TFT-E comes into an OFF state in this case. The reset signal (R), that is, potential of the gate line GL(N+1) in the subsequent row, has the L level, so that the TFT-F comes into the OFF state. Furthermore, the TFT-C comes into the ON state whereas the TFT-F comes into the OFF state, so that the netA is charged to have the power supply voltage (VSS) at the L level and the output (OUT) has potential at the L level.

When the clock signal (CKA) reaches the H level and the clock signal (CKB) reaches the L level subsequently at the time t1, the TFT-C comes into the OFF state, the netA has potential kept at the L level, and the output (OUT) has potential kept at the L level.

At time t2, the clock signal (CKA) reaches the L level, the clock signal (CKB) reaches the H level, and the start signal (S) at the H level is inputted from the gate line GL(N−1) in the preceding row. This brings the TFT-B into the ON state, so that the netA is charged to reach the H level. The TFT-C is in the ON state during this period, so that the output (OUT) has potential kept at the L level.

When the clock signal (CKA) reaches the H level and the clock signal (CKB) reaches the L level at time t3, the TFT-E comes into the ON state and the TFT-C comes into the OFF state. The capacitor Cbst is provided between the netA and the output terminal 117, so that the netA is charged to have potential at a level higher than the H level of the clock signal (CKA) as potential of the drain terminal increases in the TFT-E. Because the TFT-F is in the OFF state, potential of the netA does not decrease and potential at the H level (selection voltage) of the clock signal (CKA) is outputted from the output terminal 117 to the gate line GL(N). The gate line GL(N) is accordingly charged to reach the H level and comes into a selected state.

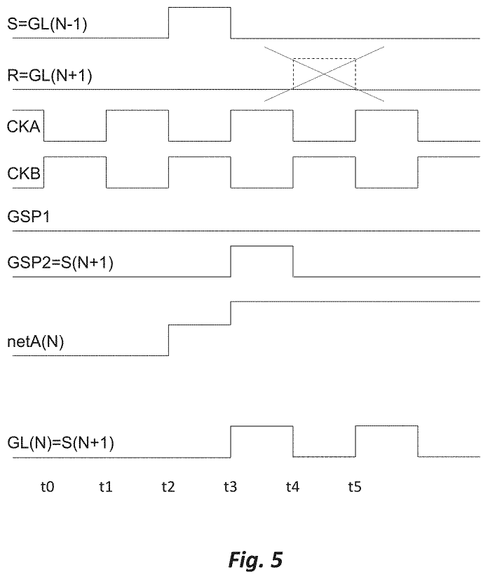

At time t4, the clock signal (CKA) reaches the L level whereas the clock signal (CKB) reaches the H level. The gate drivers 100(1) to 100(N−1) respectively receive, as the reset signals (R), selection voltage (at the H level) of the gate lines GL(2) to GL(N) in the subsequent rows at the end of selection periods, so that the TFT-F comes into the ON state, the netA is charged to reach the L level, the TFT-C comes into the ON state, and the TFT-E comes into the OFF state. Accordingly, potential at the L level (non-selection voltage) is outputted from the output terminal 117 and the gate lines GL(1) to GL(N−1) are charged to reach the L level. As indicated in FIG. 4, the gate driver 100(N) has no gate driver 100 in the subsequent row in the region G1, so that the reset signal (R) does not receive voltage at the H level. In such a case where the reset signal (R) does not receive voltage at the H level at the end of the selection period, the TFT-F does not come into the ON state. Accordingly, the netA continuously has high potential even after the end of the selection period as indicated in FIG. 5 to cause oscillation of the gate line GL(N). FIG. 5 is a waveform chart according to a comparative example of the present embodiment, indicating oscillation of the gate line GL(N) in a case where the gate driver 100(N) in the last row in the region G1 does not receive the clear signal (CLR1).

According to the present embodiment, at the time t4 at the end of the selection period (from the time t3 to the time t4), the gate driver 100(N) receives voltage at the H level as the clear signal (CLR1). Accordingly at the time t4, the TFT-A and the TFT-D come into the ON state and the netA is charged to reach the L level. The TFT-C comes into the ON state and the TFT-F comes into the OFF state, so that potential at the L level (non-selection voltage) is outputted from the output terminal 117 and the gate line GL(N) is charged to reach the L level without oscillation indicated in FIG. 5.

Though not indicated in FIG. 4, the gate driver 100(M) in the last row in the region G2 also receives voltage at the H level as the clear signal (CLR2) at the end of the selection period. The gate line GL(M) can thus be charged to have potential at the L level after the end of the selection period, without oscillation indicated in FIG. 5.

As indicated in FIG. 4, during the selection period (from the time t3 to the time t4) of the gate line GL(N) in the last row to be driven by the gate driver 100 in the region G1, the gate driver 100(N+1) in the first row in the region G2 receives the gate start pulse (GSP2) at the H level as the start signal (S). Thereafter, the gate lines GL(N+1) to GL(M) are sequentially driven by the gate drivers 100(N+1) to 100(M) in the region G2. Though not indicated in FIG. 4, the start signal (S) to be transmitted to the gate driver 100(1) in the first row in the region G1 is provided as the gate start pulse (GSP1) at appropriate timing after the selection period of the gate line GL(M) in the last row in the region G2.

As depicted in FIG. 1, the region G1 and the region G2 are not overlapped with each other in the X direction. There is accordingly provided no gate driver 100 below (on a negative side in the Y direction indicated in FIG. 1) the gate driver 100 configured to drive the gate line GL(N+1) in the first row in the region G2. The terminal 111 of the gate driver 100 configured to drive the gate line GL(N+1) has difficulty in receiving the gate output (OUT) of the gate driver 100 in the preceding row (i.e. the gate driver 100 in the last row in the region G1).

The pulse generator 110 provided outside the display region A thus transmits the gate start pulse (GSP2) as the start signal (S) to the terminal 111 of the gate driver 100 for the gate line GL(N+1), for appropriate control of drive timing of the gate lines GL(N+1) to GL(M).

### SECOND EMBODIMENT

Description is now made to the second embodiment. Components similar in configuration and function to those according to the above embodiment will be denoted by identical reference signs and will not be described in detail repeatedly. The same applies to the other embodiments to be described later.

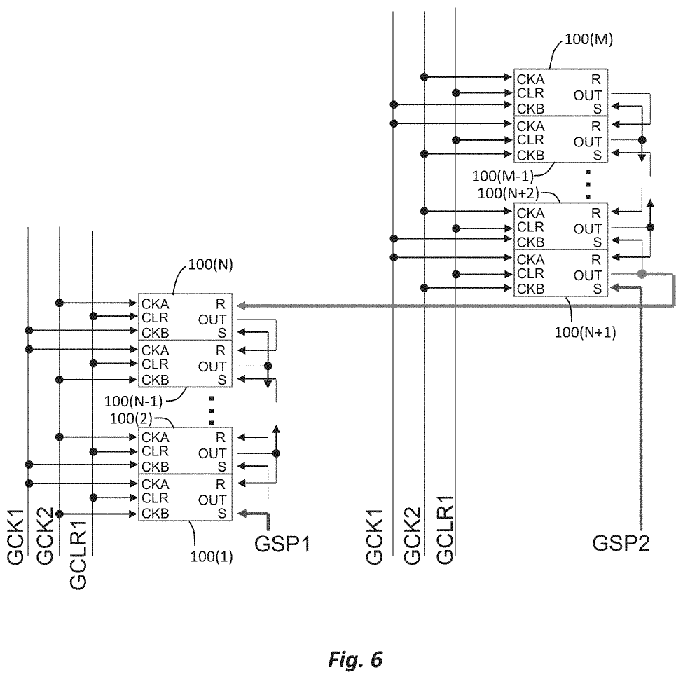

The first embodiment provides, as the control lines, the line (GCLR1) for supply of the clear signals (CLR1) to the gate drivers 100 in the region G1 and the line (GCLR2) for supply of the clear signals (CLR2) to the gate drivers 100 in the region G2. In contrast, the second embodiment provides only the line (GCLR1) as a line for supply of the clear signals, as depicted in FIG. 6. The gate driver 100(N) in the last row in the region G1 receives the gate output (OUT) of the gate driver 100(N+1) in the first row in the region G2 as the reset signal (R).

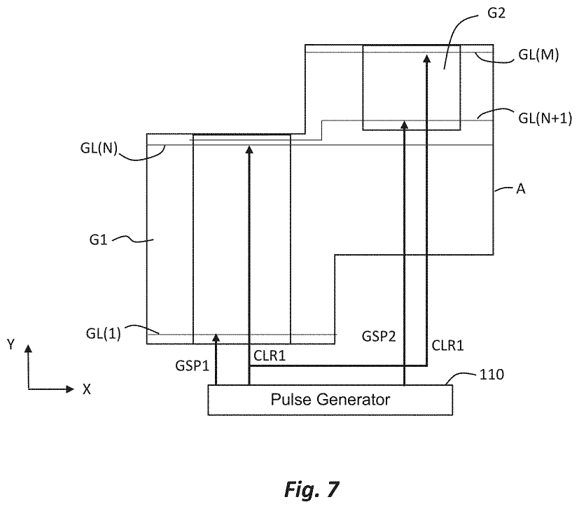

In order to transmit the gate output (OUT) of the gate driver 100(N+1) in the region G2 to the gate driver 100(N) in the last row in the region G1, the gate line GL(N+1) extends to reach the terminal 113 of the gate driver 100(N) so as not to interfere with any other line in the display region A or the frame region, as depicted in FIG. 7. FIG. 7 is a pattern diagram depicting the gate line GL(N+1) extended to the region G1, and an actual line pattern does not need to have such disposition.

FIG. 8 is a waveform chart of signals received by the gate driver 100(N) in the last row in the region G1 according to the present embodiment. As apparent through comparison between FIG. 8 and FIG. 4 according to the first embodiment, in the present embodiment, immediately after (i.e. at the time t4) the selection period (from the time t3 to the time t4) of the gate line GL(N), the gate output (i.e. selection voltage at the H level) of the gate line GL(N+1) in the subsequent row is inputted to the terminal 113 of the gate driver 100(N) as the reset signal (R).

The TFT-F comes into the ON state, the netA is charged to reach the L level, the TFT-C comes into the ON state, and the TFT-E comes into the OFF state in this case, so that potential at the L level (non-selection voltage) is outputted from the output terminal 117 and the gate line GL(N) is charged to reach the L level.

Though not indicated in FIG. 8, the clear signal (CLR1) according to the present embodiment reaches the H level only once during a single vertical scan period, at the end of the selection period of the gate line GL(M) in the last row. The netAs in all the gate drivers 100 and all the gate lines GL are accordingly charged to reach the L level.

As described above, according to the present embodiment, the gate driver 100(N) in the last row in the region G1 is supplied with the gate output in the first row in the region G2 as the reset signal (R). In comparison to the first embodiment that needs the two types of clear signals (CLR1 and CLR2), the present embodiment achieves reduction in the number of input signals and simplification in circuit configuration.

### THIRD EMBODIMENT

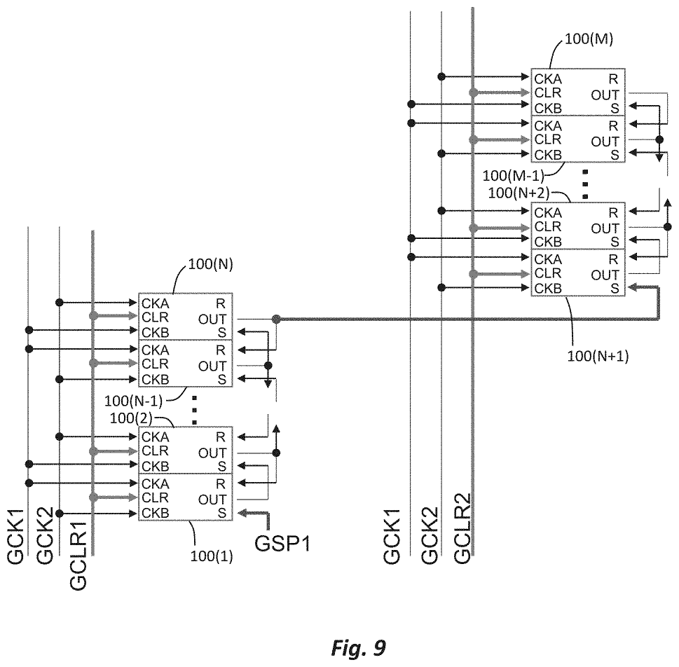

As depicted in FIG. 9, the present embodiment is different from the first embodiment in that the gate driver 100(N+1) in the first row in the region G1 receives the gate output (OUT) in the last row in the region G2 as the start signal (S). The remaining configurations according to the present embodiment are similar to those according to the first embodiment.

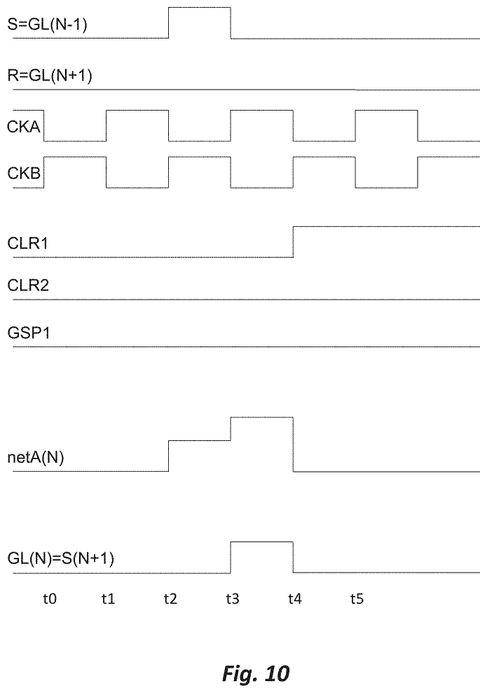

FIG. 10 is a waveform chart of signals received by the gate driver 100(N) in the last row in the region G1 according to the present embodiment. As apparent through comparison between FIGS. 9 and 10 and FIGS. 3 and 4 according to the first embodiment, the present embodiment does not need the gate start pulse (GSP2) for the region G2.

As depicted in FIG. 9, the gate driver 100(1) in the first row in the region G1 according to the present embodiment receives, as the start signal (S), the gate start pulse (GSP1) from the pulse generator 110. Meanwhile, the gate driver 100(N+1) in the first row in the region G2 receives, as the start signal (S), a selection signal of the gate line GL(N) driven by the gate driver 100(N) in the region G1. Thereafter, the gate lines GL(N+1) to GL(M) are driven sequentially.

As described above, the gate driver 100(N+1) in the first row in the region G2 according to the present embodiment is supplied with the gate output in the last row in the region G1 as the reset signal (R). In comparison to the first embodiment that needs the two types of gate start pulses (GSP1 and GSP2), the present embodiment achieves reduction in the number of input signals and simplification in circuit configuration.

### FOURTH EMBODIMENT

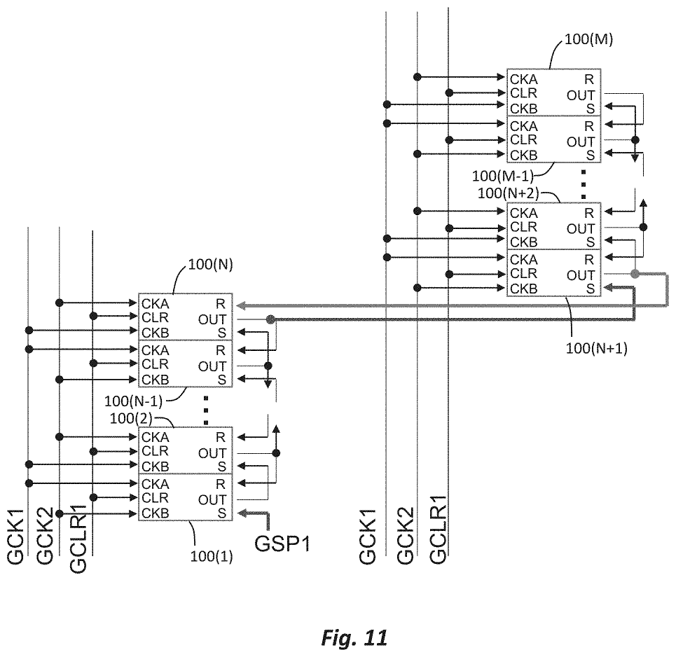

The fourth embodiment is achieved by combining the second embodiment and the third embodiment. Specifically, the present embodiment provides only the line (GCLR1) as a line for supply of the clear signals, as depicted in FIG. 11. The gate driver 100(N) in the last row in the region G1 receives the gate output (OUT) of the gate driver 100(N+1) in the first row in the region G2 as the reset signal (R). Furthermore, the gate driver 100(N+1) in the first row in the region G1 receives, as the start signal (S), the gate output (OUT) in the last row in the region G2.

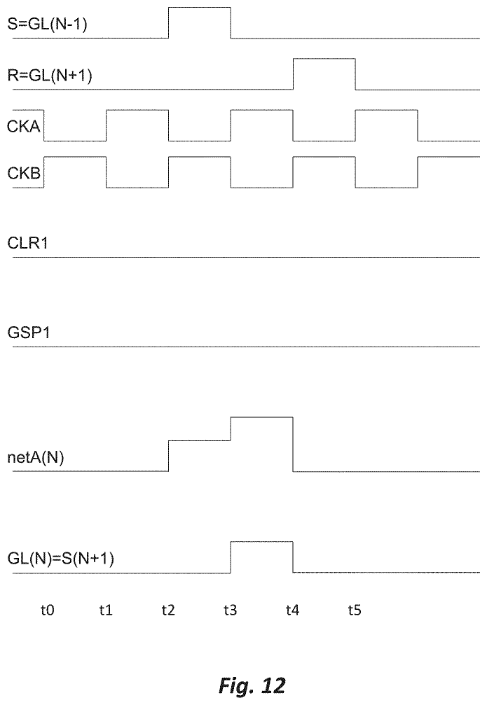

FIG. 12 is a waveform chart of signals received by the gate driver 100(N) in the last row in the region G1 according to the present embodiment. As apparent through comparison between FIGS. 11 and 12 and FIGS. 3 and 4 according to the first embodiment, the present embodiment needs neither the clear signal (CLR2) nor the gate start pulse (GSP2) and thus achieves reduction in the number of signals and simplification in circuit configuration in comparison to the first embodiment.

The several embodiments have been described above for mere exemplification. The present invention should not be limited to the above embodiments, and can be achieved with appropriate modifications to or combinations of the above embodiments without departing from the spirit of the present invention.

The TFT-A to the TFT-F constituting the gate driver 100 each include a semiconductor layer made of an oxide semiconductor, polysilicon, amorphous silicon, or the like. The same applies to the switching elements configured to drive respective pixels in the display region A.

The above embodiments each exemplify the configuration in which all circuit elements configured to drive the gate lines are disposed inside the display region A. Alternatively, the circuit elements configured to drive the gate lines may be partially disposed outside the display region A.

1. A display device comprising, inside a display region having a nonrectangular shape:
a plurality of gate lines;
a plurality of source lines crossing the plurality of gate lines; and
a plurality of gate drivers configured to respectively drive the plurality of gate lines;
the display device further comprising:
a pulse generator provided outside the display region; wherein
the plurality of gate lines include a plurality of groups of gate lines different in at least either scan start lines or scan end lines,
the plurality of gate drivers include a plurality of groups of gate drivers respectively for the plurality of groups of gate lines, the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by the pulse generator or a group of gate drivers that scans the gate lines before the other group of gate drivers during the single vertical scan period, and
a scan end signal is transmitted to each of the plurality of groups of gate drivers by the pulse generator or a group of gate drivers configured to scan the gate lines subsequently to the each of the plurality of groups of gate drivers during the single vertical scan period.

2. The display device according to claim 1, wherein
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by the pulse generator, and
a scan end signal is transmitted to each of the plurality of groups of gate drivers by the pulse generator.

3. The display device according to claim 1, wherein
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by the pulse generator, and
the plurality of groups of gate drivers includes a group of gate drivers to which a scan end signal is transmitted by a subsequent group of gate drivers configured to scan the gate lines subsequently to the group of gate drivers during the single vertical scan period.

4. The display device according to claim 1, wherein
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by a group of gate drivers that scans the gate lines before the other group of gate drivers during the single vertical scan period, and
a scan end signal is transmitted to each of the plurality of groups of gate drivers by the pulse generator.

5. The display device according to claim 1, wherein
the pulse generator transmits a scan start signal to a first group of gate drivers, among the plurality of groups of gate drivers, that includes a gate driver configured to drive a gate line from which a scanning in a single vertical scan period starts,
to other group of gate drivers than the first group of gate drivers, among the plurality of groups of gate drivers, a scan signal is transmitted by a group of gate drivers that scans the gate lines before the other group of gate drivers during the single vertical scan period, and
the plurality of groups of gate drivers includes a group of gate drivers to which a scan end signal is transmitted by a subsequent group of gate drivers configured to scan the gate lines subsequently to the group of gate drivers during the single vertical scan period.
